(19) United States
(12) Patent Application Publication
(10) Pub. No.: US 2022/0368538 A1
(43) Pub. Date: Nov. 17, 2022

(54) ZERO-KNOWLEDGE PROOF BASED CROSS-CHAIN INTEROPERABILITY

(71) Applicant: ToposWare Japan Inc., Tokyo (JP)

(72) Inventors: Theo Kevin Gauthier, Cambridge, MA (US); Robin Salen, Chateaubriant (FR); Monir Hadji, Tokyo (JP); Sebastien Paul-Edouard, Thomas Dan, Cambridge, MA (US)

(21) Appl. No.: 17/730,448

(22) Filed: Apr. 27, 2022

Related U.S. Application Data
(60) Provisional application No. 63/180,606, filed on Apr. 27, 2021.

(51) Int. Cl. H04L 9/32; H04L 9/00

(52) U.S. Cl. CPC H04L 9/3265; H04L 9/50; H04L 9/3218

(57) ABSTRACT

A system and a method are disclosed for enabling cross-chain transactions between a first blockchain and a second blockchain. A certificate for a cross-chain transaction processed by a sidechain is received. Additionally, a verification key associated with the sidechain is received. Moreover, information related to the cross-chain transaction processed by the sidechain is received. Based on the verification key associated with the sidechain, the validity of the certificate is verified using a zero-knowledge proof. In response to determining the validity of the certificate, the cross-chain transaction is processed based on the received information related to the cross-chain transaction processed by the sidechain.

### CROSS REFERENCE TO RELATED APPLICATIONS

This application claims the benefit of U.S. Provisional Application No. 63/180,606, filed Apr. 27, 2022, which is incorporated by reference in its entirety.

### BACKGROUND

One inherent problem in some blockchain systems is the challenge in allowing two or more independent blockchains to interoperate with each other. For example, it might be beneficial to allow two blockchains to perform cross-chain transactions (e.g., transferring assets such as coins between the two blockchains). Some early solutions for allowing the interoperability between blockchains relied on the blockchains to have a certain degree of trust among them, or relied on the blockchains having to reveal private information to allow third parties to interact with them. For example, in some systems, to allow for the interaction between two blockchains, the blockchains may communicate with an entity that is trusted by both entities which is then able to facilitate the transaction between the two blockchains. However, none of these solutions are suitable when there is no such entity that the blockchains trust that can act as the intermediary. Moreover, in some scenarios, revealing private information to allow other entities to interact with the blockchain might not be desirable. As such, there is a need for a protocol that allows for the interoperability of blockchains that does not rely on a level of trust among two or more entities, and does not rely on the disclosure of private information.

### SUMMARY

A system and a method are disclosed for enabling cross-chain transactions between a first blockchain and a second blockchain. A certificate for a cross-chain transaction processed by a sidechain is received. Additionally, a verification key associated with the sidechain is received. Moreover, information related to the cross-chain transaction processed by the sidechain is received. Based on the verification key associated with the sidechain, the validity of the certificate is verified using a zero-knowledge proof. In response to determining the validity of the certificate, the cross-chain transaction is processed based on the received information related to the cross-chain transaction processed by the sidechain. In some embodiments, upon processing the cross-chain transaction, an acknowledgement for the cross-chain transaction is sent to the sidechain.

In some embodiments, the certificate is received from a distributed file system. For instance, upon processing the cross-chain transactions, the sidechain may send the certificate for the cross-chain transaction to the distributed file system. Upon receiving the certificate, the distributed file system may send the certificate to entities (such as other sidechains) registered to receive certificates from the sidechain. In some embodiments, in order to receive the certificate for the cross-chain transaction processed by the sidechain, a storage identifier within the distributed file system and associated with the sidechain is received. Moreover, based on the storage identifier associated with the sidechain, the distributed file system is accessed to retrieve the certificate for the cross-chain transaction processed by the sidechain.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a block diagram of a system environment in which multiple blockchains operate, according to one or more embodiments.

FIG. 2 illustrates a flow diagram for enabling interoperability between two or more blockchains, according to one or more embodiments.

FIG. 3 illustrates a flow diagram of a process for creating or registering a new blockchain, according to one or more embodiments.

FIG. 4 illustrates a flow diagram of a process for subscribing to a sidechain, according to one or more embodiments.

FIGS. 5A and 5B illustrate a flow diagram of a process in which a second sidechain interacts with a first sidechain, according to one or more embodiments.

FIG. 6 illustrates cross-chain transactions and their acknowledgment by the terminals, according to one or more embodiments.

FIG. 7 illustrates the use of IPFS for Cert and block publication and resolution, according to one or more embodiments.

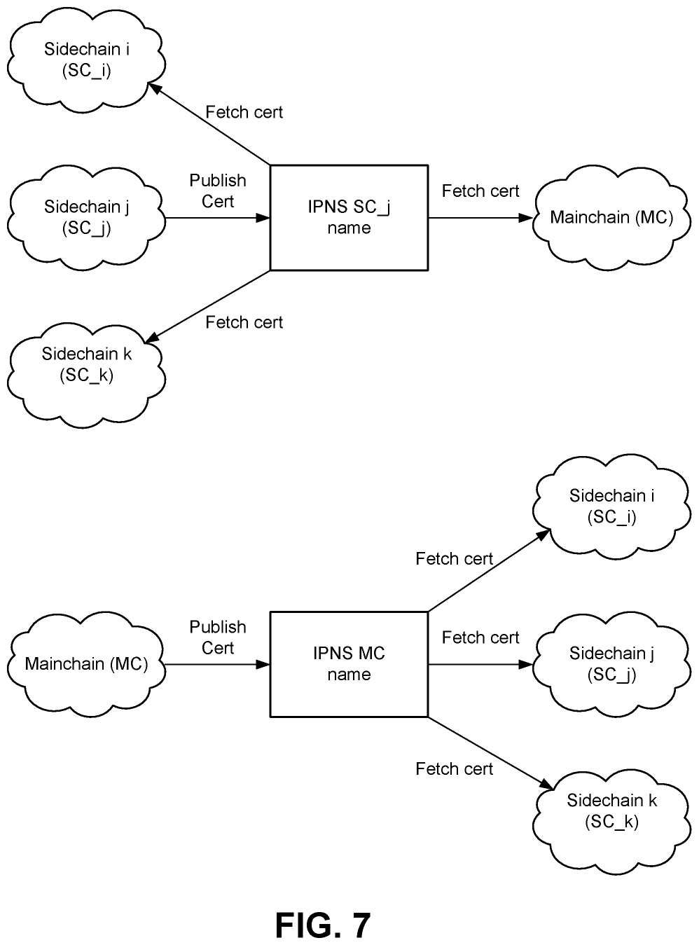

FIG. 8 illustrates a process for combining private shares to generate a valid signature a on a specific data, according to one or more embodiments.

FIG. 9 illustrates data published under IPNS names over time, according to one or more embodiments.

FIG. 10 illustrates one embodiment of components of an example machine able to read instructions from a machine-readable medium and execute them in a processor (or controller).

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

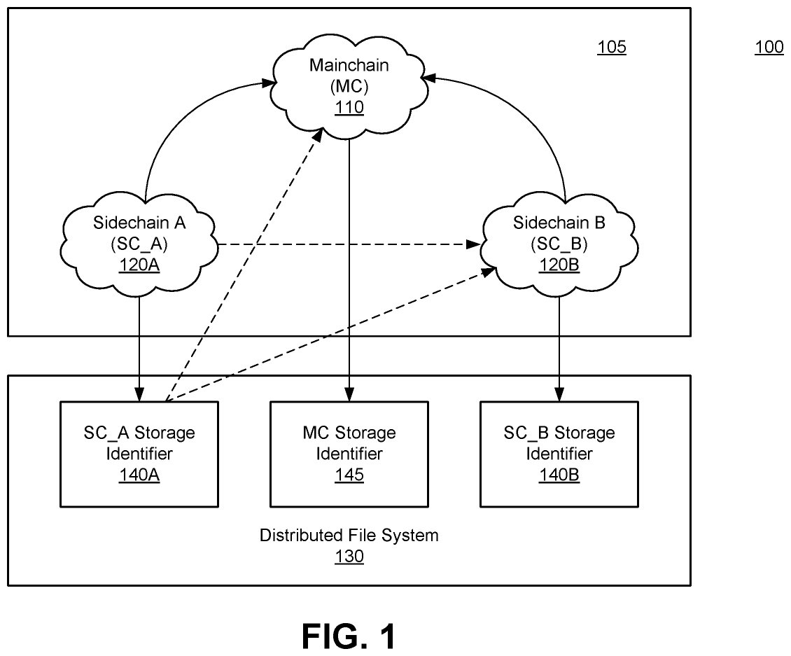

Figure (FIG. 1 illustrates a block diagram of a system environment 100 in which multiple blockchains operate, according to one or more embodiments. The system environment 100 includes a mainchain 110, multiple sidechains 120, and a distributed file system 130 (e.g., the interplanetary file system (IPFS)). Although the example of FIG. 1 shows two sidechains 120, it is understood that the system environment 100 may include any number of sidechains 120.

The mainchain 110 is a blockchain that is configured to interact with a set of sidechains 120. The mainchain stores information relevant to the sidechains 120. For example, the mainchain 110 stores information for verifying transactions that occur in each of the sidechains 120, information for locating each of the sidechains 120, or information relating to a number of tokens expected to be available in each of the sidechains 120. In some embodiments, an entity trying to interact with a sidechain is able to retrieve the information for enabling the interaction in one or more blocks of the mainchain 110. Moreover, in some embodiments, assets (e.g., digital tokens) in the mainchain might be linked or transferred to a sidechain to allow the transferred asset to be managed (e.g., traded) in the corresponding sidechain 120.

The sidechains 120 are blockchains that run in parallel with the mainchain 110. In some embodiments, each sidechain 120 keeps an independent ledger containing a set of records (e.g., blocks). In some embodiments, each sidechain 120 may use a specific algorithm for generating new blocks. The algorithm used by a particular sidechain 120 might be kept private and might be unknown by parties that are not associated with the sidechain 120.

In some embodiments, sidechains 120 are registered on the mainchain 110 upon their creation. That is, when a sidechain 120 is created, information about the sidechain is recorded in the mainchain 110 to allow other sidechains 120 to interoperate with the newly created sidechain 120. In some embodiments, one or more assets (e.g., tokens) can be transferred from the mainchain 110 to the sidechain 120 when the sidechain is registered.

Alternatively, already existing and running blockchains might be registered with the mainchain 110 to become a sidechain 120. In this embodiment, information about the sidechain is provided to the mainchain 110 and stored in a block of the mainchain 110.

The distributed file system 130 allows information to be shared among between one or more sidechain and the mainchain, and between two or more sidechains. Each sidechain 120 is associated with one or more specific locations or storage identifiers 140 (e.g., name or address) within the distributed file system 130. In some embodiments, the mainchain 110 is also associated with one or more specific locations or storage identifiers 145 within the distributed file system 130. Each of the sidechains publish or store data to be shared with the mainchain 110 or other sidechains 120 at locations associated with the storage identifier 140 associated with the sidechain 120. For example, sidechain A 120A publishes or stores data to be shared with the mainchain 110 or sidechain B 120B at locations associated with the storage identifier 140A. In some embodiments, the sidechains store, in the distributed file system Y30, certificates for one or more transactions performed in the sidechain. Other sidechains 120 and the mainchain 110 may retrieve the certificates stored in the distributed file system 130 at locations associated with the storage identifier 140A associated with sidechain 120A to verify the validity of the transactions performed in the sidechain 140A.

### Cross-Sidechain Interoperability Overview

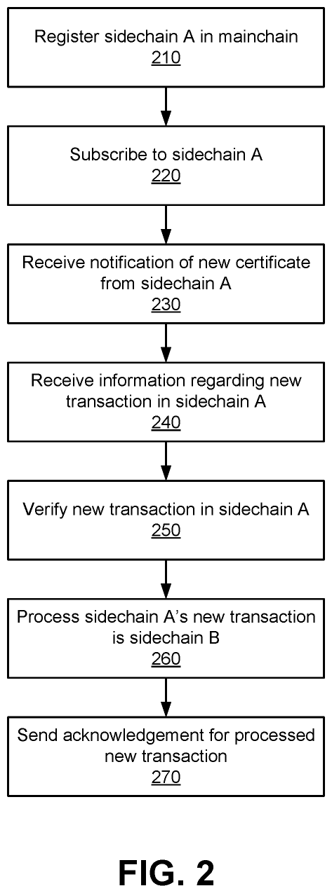

FIG. 2 illustrates a flow diagram for enabling interoperability between two or more blockchains, according to one or more embodiments.

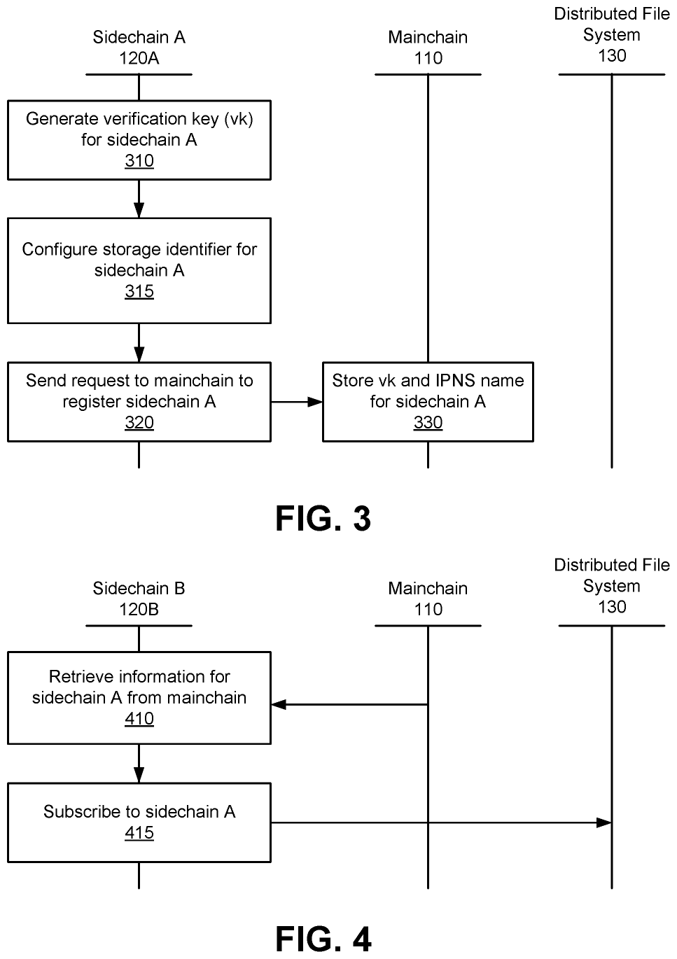

A first sidechain 120A is registered 210 in the mainchain 110. To register the first sidechain 120A in the mainchain 110, a request including at least a prespecified set of information (such as an identifier of the first sidechain 120A, a verification key (vk) for the first sidechain 120A, and a storage identifier 140 (such as a name or an address) within the distributed file system 130 for the first side chain 120A) is stored on the mainchain 110. The mainchain 110 then creates a new block and includes the information for the first sidechain 120A in the newly created block. The process for registering a first sidechain 120A is described in more detail in conjunction with FIG. 3.

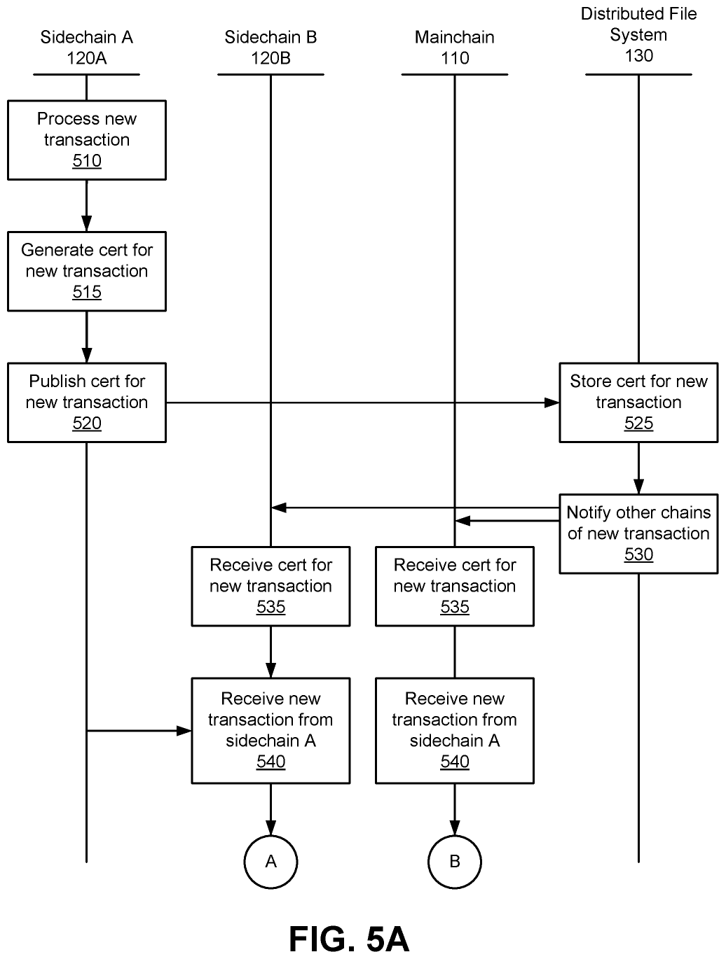

A second sidechain 120B subscribes 220 to the first sidechain 120A. To subscribe to the first sidechain 120A, the second sidechain 120B retrieves the information regarding the first sidechain 120A from the mainchain. In some embodiments, the second sidechain 120B retrieves at least the storage identifier 140A associated with the first side chain 120A. In some embodiments, the second sidechain 120B sends a request to the distributed file system 130 to receive notification whenever new data is published or stored at locations associated with the storage identifier 140 associated with the first sidechain 120A. Alternatively, the second sidechain 120B periodically monitors the distributed file system 130 to determine whether new data has been stored at locations within the distributed file system 130 associated with the storage identifier 140A associated with the first sidechain 120A. In yet other embodiments, the second sidechain 120 listens to a specific storage identifier 140A in the distributed file system 130 associated with the first sidechain 120A. For example, the storage identifier 140A is an InterPlanetary Name System (IPNS) name. The process for subscribing to the first sidechain 120A is described in more detail in conjunction with FIG. 4.

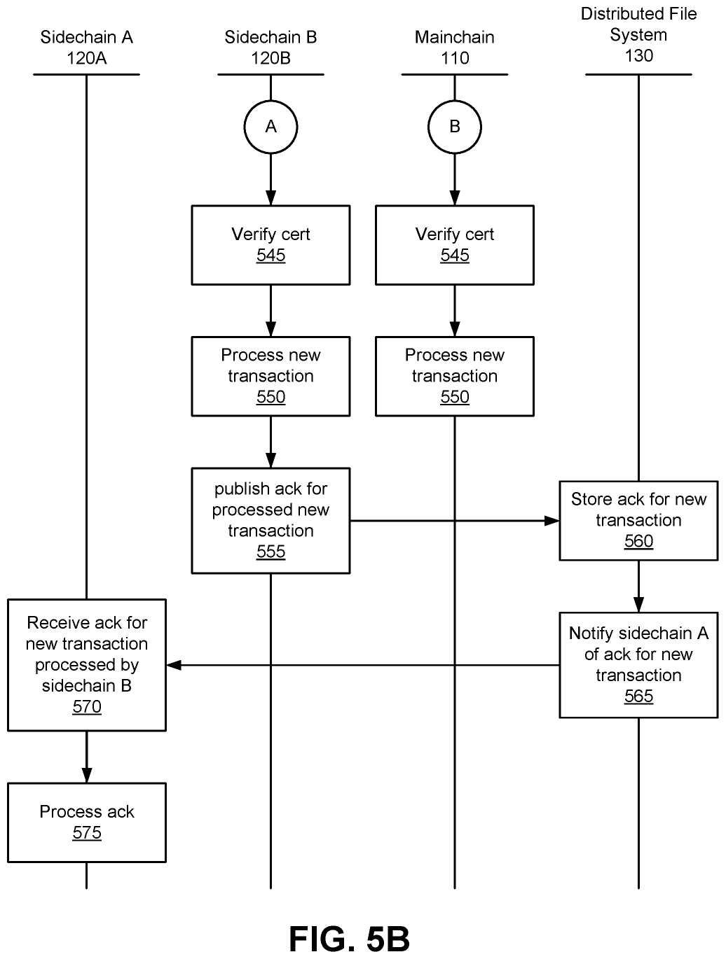

The second sidechain 120B receives 230 a notification of a new certificate associated with one or more cross-chain transactions processed by the first sidechain 120A. In some embodiments, the second sidechain 120B receives the notification from the distributed file system 130. Alternatively, the second sidechain 120B receives the notification form the first sidechain 120A. In some embodiments, the second sidechain 120B receives a notification each time a new certificate is processed by the first sidechain 120A. In other embodiments, the second sidechain 120B receives a notification when a new certificate for the second sidechain 120B is processed by the first sidechain 120A. The process for receiving a notification about a new certificate processed by the first sidechain 120A is described in more detail in conjunction with FIG. 5A.

The second sidechain 120B receives 240 information about the new transaction processed by the first sidechain 120A and verifies 250 the transaction. In some embodiments, the second sidechain 120B receives the transaction from the first sidechain 120A and receives a certificate published by the first sidechain 120A from the distributed file system 130. The process verifying a new transaction processed by the first sidechain 120A is described in more detail in conjunction with FIGS. 5A-5B.

Once the second sidechain 120B has verified the new transaction processed by the first sidechain 120A, the second sidechain 120B processes the new transaction (cross-chain transaction). If the second sidechain 120B successfully processes the new transaction, the second sidechain 120B sends 270 an acknowledgment for the processed transaction. The process processing a new cross-chain transaction and sending an acknowledgment for the cross-chain transaction is described in more detail in conjunction with FIG. 5B.

FIG. 3 illustrates a flow diagram of a process for creating or registering a new blockchain, according to one or more embodiments.

A verification key (vk) is generated 310 for the first sidechain 120A. In some embodiments, the verification key is generated based on a predetermined verification algorithm, such as a predetermined non-interactive zero-knowledge proof algorithm. For example, the predetermined verification algorithm is a zero-knowledge succinct non-interactive argument of knowledge (zk-SNARK) proof.

In some embodiments, the storage identifier 140A for the first sidechain 120A is configured 315. For example, the first sidechain 120A is configured to publish certificates at a location associated with a specific identifier. For example, the specific identifier is an identifier associated with a public key for the first sidechain 120A that is used to sign the certificates published by the first sidechain 120A (e.g., a hash of the public key associated with the first sidechain 120A).

The sidechain 120A sends 3 a request to the mainchain 110 to be registered within the mainchain 110. The main chain then includes the information for interacting with the sidechain 120A within a new block of the ledger of the mainchain 110.

FIG. 4 illustrates a flow diagram of a process for subscribing to a sidechain, according to one or more embodiments.

A second sidechain 120B that wants to interact with the first sidechain 120A retrieves 410 information about the first sidechain 120A from the mainchain 110. For example, the second sidechain 120B access the block in the mainchain ledger that contains the information regarding the first sidechain and retrieves the verification key and the storage identifier 140A for the first sidechain 120A. By retrieving the information from the mainchain, the second sidechain does not have to rely on a trust that the first sidechain 120A is providing accurate information. Using the information retrieved from the mainchain 110, the second sidechain 120B subscribes to the first sidechain 120A. In some embodiments, to subscribe to the first sidechain 120A, the second sidechain 120B communicates with the distributed file system 130. For example, the second sidechain 120B may send a request to the distributed file system 130 to subscribe to the storage identifier 140A for the first sidechain 120A. Alternatively, to subscribe to the first sidechain 120A, the second sidechain 120B communicates with the first sidechain 120A.

FIGS. 5A and 5B illustrate a flow diagram of a process in which a second sidechain interacts with a first sidechain, according to one or more embodiments.

The first sidechain 120A processes 510 a new transaction. For example, the first sidechain 120A creates a new block in the ledger associated with the first sidechain 120A that includes the new transaction. Moreover, in some embodiments, the new transaction is a cross-chain transaction. That is, the new transaction is a transaction involving multiple sidechains 120.

The first sidechain 120A generates 515 a certificate for the new transaction. In some embodiments, to generate the certificate, a proof for verifying the validity of the new transaction is generated. In some embodiments, the proof is generated using a proving key associated with the first sidechain 120A. In some embodiments, the proving key is associated with the verification key for the first sidechain 120A (i.e., the verification key stored in the mainchain 110). In some embodiments, a verifier (such as the second sidechain 120B) uses a verification function associated with a zero-knowledge proof algorithm that allows the verifier to verify the validity of the new transaction using the proof and the verification key associated with the first sidechain 120A but without knowing the details of the new transaction itself. That is, the zero-knowledge proof algorithm allows for the verifier to confirm that the new transaction has been properly processed by the first sidechain 120A without the first sidechain WW20A revealing private or confidential information about the first sidechain and the new transaction.

The first sidechain 120A publishes 520 the certificate for the new transaction. In some embodiments, to publish the certificate for the new transaction, the first sidechain 120A sends the certificate to the distributed file system 130 to be cached or stored. In some embodiments, upon receipt of the certificate, the distributed file system 130 caches or stores 525 the certificate and associates the location the certificate was stored at with the storage identifier 140A associated with the first sidechain 120A.

In some embodiments, the distributed file system 130 notifies 530 chains that are subscribed to the first sidechain 120A. In the example of FIG. 5A, the distributed file system 130 notifies 530 the second sidechain 120B and the mainchain 110. In some embodiments, the first sidechain 120A notifies the chains subscribed to it instead. In another embodiment, the chains that are configured to interact with the first sidechain 120A periodically checks the distributed file system 130 to determine whether a new certificate for the first sidechain 120A has been stored.

The chains subscribed to the first sidechain 120A receives 535 the certificate for the new transaction. In the example of FIG. 5A, the second sidechain 120B and the mainchain 110 receive 535 the certificate for the new transaction. In particular, upon receiving a notification (from the distributed file system 130 or from the first sidechain 120A) that a new transaction has been processed by the first sidechain 120A, the second sidechain 120B and the mainchain 110 retrieve the certificate from the locations within the distributed file system 130 associated with storage identifier 140A associated with the first sidechain 120A.

The chains subscribed to the first sidechain 120A receive 540 information about the new transaction. In some embodiments, the information about the new transaction is received from the first sidechain 120A.

Based on the information about the new transaction and the certificate, the second sidechain 120B verifies 545 the validity of the new transaction. In some embodiments, based on the information about the new transaction and the certificate, the mainchain 110 also verifies the validity of the new transaction. In some embodiments, the verification of the validity of the new transaction is performed using a zero-knowledge proof algorithm using the verification key for the first sidechain that is stored in the mainchain 110.

Once the second sidechain 120B has verified the new transaction, the second sidechain 120B processes 555 the new transaction as a cross-chain transaction. Upon completion of the processing of the new transaction, the second sidechain 120B publishes 555 an acknowledgment for the cross-chain transaction. In some embodiments, the second sidechain 120B publishes the acknowledgment for the cross-chain transaction at locations within the distributed file system 130 associated with the storage identifier 140B associated with the second sidechain. That is, the second sidechain 120B sends the acknowledgment to the distributed file system 130 and the distributed file system 130 caches or stores 560 the acknowledgment for the cross-chain transaction at the storage identifier 120B associated with the second sidechain 120B. In some embodiments, the distributed file system 130 stores the acknowledgment and associates the location where the acknowledgment was stored with the storage identifier 140B associated with the second sidechain 120B.

In some embodiments, the first sidechain 120A gets notified 565 of acknowledgment for the cross-chain transaction. For example, the distributed file system 130 (or alternatively the second sidechain 120B) notifies 565 the first sidechain 120A that the second sidechain 120B has published a new acknowledgment for a cross-chain transaction in a location within the distributed file system 130 associated with the storage identifier 140B associated with the second sidechain 120B. Alternatively, the first sidechain 120A periodically checks the distributed file system at the storage identifier 140B associated with the second sidechain 120B to determine if a new acknowledgment for the cross-chain transaction has been published. Upon receiving the notification or upon determining that a new acknowledgment is available, the first sidechain receives 570 or retrieves the acknowledgment for the cross-chain transaction from the distributed file system 130 and processes 575 the acknowledgment.

### Technology Framework

By way of example, an MC_coin may be a cryptocurrency issued by the mainchain (MC). An Availability may be the ability for off-chain processes to retrieve data from the blockchain (BC) within some time bound. Validators may be known entities on the network 105 and their role is to participate in the consensus mechanism to produce the MC blocks. Any instance of non-compliance with the consensus algorithm results in punishment by removal of some or all of the validator's staked MC_coin, thereby discouraging bad behavior. Good conduct, however, is rewarded, with validators receiving block rewards in the form of MC_coin in exchange for their activities. The number of validators is n and the set of validators is referred to as (Vᵢ)_{i∈[n]}.

A cross-chain Protocol (XCP) may be a protocol that enables XC transactions and more generally describes the interactions between actors of a multi-chain ecosystem. A cross-chain (XC) transaction may be a transaction which involves two blockchains, with at least one being on the network 105. A Cross-sidechain (XSC) transaction may be a XC transaction between two different SC (an Initial and a Terminal). Formally, a XSC transaction may be defined as XSC: SCᵢ→SCⱼ where SCᵢ is the Initial, and SCⱼ is the Terminal. Additionally, the notation XSC_{i→j} may be used to denote a XSC transaction between SCᵢ and SCⱼ.

An Initial may be a source SC of a XC transaction (“the Initial of the XC transaction”). Formally, a SCᵢ is an Initial if ∃XC_{i→BC}.

A Terminal may be a target SC of a XC transaction (“the Terminal of the XC transaction”). Formally, a SCᵢ is a Terminal if ∃XC_{BC→i}.

An up transaction (UpTx) may be a transaction from a SC to the MC. Formally, an UpTx may be defined as UpTx [symbol] XC_{i→MC}.

A down transaction (DownTx) may be a transaction from the MC to a SC. Formally, a DownTx may be defined as DownTx [symbol] XC_{MC→i}.

[symbol] ⊂ [symbol] is the index set of all SC.

The Listeners of a SC may be a set of SC that are listening to a given SC. [symbol] ᵢ is the set of Listeners that are listening to SCᵢ. A SC listening to SCᵢ means that it is fetching the data published by SCᵢ. For example, [symbol] are the Listeners of SCᵢ.

A certificate (Cert) may be a piece of data sent by a SC to the MC or to another SC in order to prove state validity for specific transactions. A certification may be in the context of a certificate verification. Upon successful verification of the certificate, the MC and/or Terminals consider the included [symbol] as Certified. A finality, used in the context of a consensus mechanism, may be the quantifiable assurance provided by a consensus algorithm that a particular block will not be reverted, subject to certain assumptions about the behavior of the validator set. With BFT (Byzantine fault-tolerant) protocols, finality is reached upon assumption of having n≥3f+1 where n is the number honest nodes, and f is the number of Byzantine nodes. A SNARK (Succinct Non-interactive Arguments of Knowledge) may be are non-interactive systems with short proofs (i.e., independent of the size of the witness) that enable verifying nondeterministic polynomial time (NP) computations with substantially lower complexity than that required for classical NP verification.

A Merkle Mountain Range (MMR) may be a specific construction of Merkle Tree endowed with an optimized append function compared to standard Merkle Tree. As with regular Merkle Trees, the root changes whenever any leaf changes. This is used in for the Cert to ensure that any changes in the list of Cert can be detected. An IPNS name may be a name or address under which some data can be published by an authenticated actor and then resolved by many other actors in the IPFS network. In some embodiments, data is not published by a single actor but by multiple actors in a distributed network which agree on which value to publish. An example would be an IPNS name for a SC: data to be written is published by relevant participants of the SC and then resolved by nodes that are outside of the SC. Ceasing may be an action of the MC to punish a SC which published a Cert with wrong proof or did not properly pin all its Cert on IPFS. A ceased SC will be considered out of the ecosystem by the MC and will not be able to do XC transactions anymore.

### Cross-Chain Protocol

A. Mainchain (MC)

The MC consensus is a hybrid protocol composed of a block production mechanism which provides probabilistic finality and a finality gadget which provides deterministic finality. The finality gadget is a partially synchronous BFT protocol, and as such is correctly enforced if f<⅓ of the voting power (the validators) is Byzantine. However, if f≥⅓ of the validators are Byzantine, one of the three cases below is implemented.

If ½>f≥⅓ of the validators are Byzantine, the BFT protocol stops and the system falls back to the probabilistic finality of the block production mechanism which itself never halts. Forks may exist but would be resolved under the standard security assumption of the block production mechanism.

If ⅔>f≥½ of the validators are Byzantine, the security of the probabilistic finality falls so invalid forks can become the common prefix of the chain leading to invalid states being propagated. Moving back to f<⅓ Byzantine validators ensures deterministic finality of the correct fork.

If f>⅔ of the validators are Byzantine, the failure is total and not recoverable via the consensus and invalid states will be finalized as part of the canonical chain. In some embodiments, to recover from this scenario, a hard fork is created.

Validators are disincentivized to behave maliciously for they commit to a security deposit (a portion of their stake) that will be destroyed (slashing) in case bad actions are reported.

In the ecosystem, the main role of the MC is to rule the emission of the MC_coin asset as well as verifying Cert from all the sidechains.

B. Creation of a Sidechain

To create a SC, the SC is registered in the MC, a process that uses a predefined set of inputs among which are:
The verification key vk that is used to verify the SNARK proof of the Cert provided by the SC.
The sc_{data} definition of the extra information that the SC will provide in the Cert.
An initial amount of MC_coin to transfer from the MC to the SC.
The initial IPNS name for the SC.

In some embodiments, the sidechain creation is initiated in the mainchain via a special transaction. The provided inputs listed above are then stored in a MC block within this transaction.

In some embodiments, it is possible for an already existing and running blockchain to get registered to the MC. The system 100 may implement a special transaction which allows storing the SNARK verification key of an already existing blockchain into the mainchain.

C. Sidechain

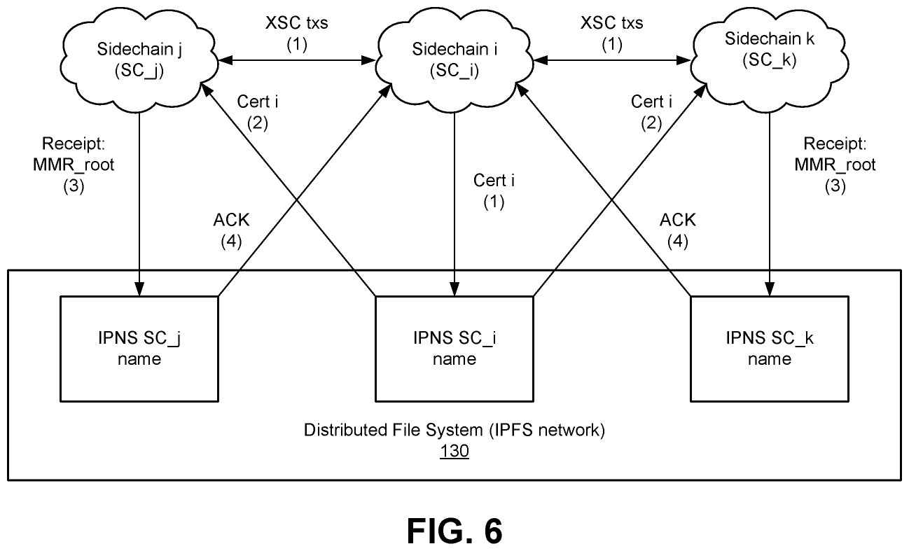

FIG. 6 illustrates cross-chain transactions and their acknowledgment by the terminals, according to one or more embodiments.

When SCᵢ wants to emit transactions towards its listeners [symbol] ᵢ (i.e., a cross-chain transactions [symbol] ), SCᵢ aggregates all the [symbol] transactions and publishes them on IPFS inside a Cert that includes also a proof π that these transactions are sound.

More formally, a Cert is defined as:
Certₙ:={SCId,nonceₙ,MMR_rootₙ₋₁,(XC [symbol] )sc_{data}, πₙ}
   where:
SCId is the unique identifier of the SC
nonceₙ is an integer incremented by 1 at each Cert (nonceₙ=nonceₙ₋₁+1)
MMR_rootₙ₋₁ is the root of the MMR that committed to the previous certificate Certₙ₋₁
XC [symbol] =UpTxList∪XSC [symbol] represents the list of all the transactions SCᵢ made to [symbol] and to the MC
sc_{data} is a part of the input data that is defined by the SC and passed along the certificate.

In some embodiments, sc_{data} is a list of variables of predefined types whose semantics are not known to the MC.
πₙ is the SNARK proof.

Listeners and the MC verify the certificate proof πₙ via the following interface:
Verify(vkᵢ,publicᵢₙₚᵤₜ, πₙ)
   where:
vkᵢ is the SNARK verification key of SCᵢ
publicᵢₙₚᵤₜ:=(cert_{data},Merkle_Root(sc_{data}))
   where, cert_{data}:=(Merkle_Root(XC [symbol] ), πₙ₋₁)

The public input of the SNARK is unified for all sidechains. Therefore, each sidechain can fetch the verification key vk of any other sidechain from the MC to verify the Cert proof.

The protocol has SCᵢ directly publish its certificates on IPFS for verification by the Listeners and the MC.

The resolution of Cert can be described by looking at the consequences of the following event:

«SCᵢ emits Certₙ, along with its MMR_rootₙ, under its IPNS name»

As a consequence, each Listener [symbol] will be notified and follow these steps:
Fetch Certₙ and its associated MMR_rootₙ from the IPNS name of the Initial
Compute the MMR_rootₙ from MMR_rootₙ₋₁ and Certₙ, and checking if it is equal to the MMR_rootₙ provided by SCᵢ
Verify each XCS_{i→j} transaction
Publish the MMR_rootₙ under its IPNS name

### Communication Protocol

Processes in a communication protocol can be decoupled in two ways:
Temporally: Sender and Receiver are not necessarily live at the same time, e.g. a telephone call is a temporally coupled model, a mailbox isn't.
Referentially: Sender and Receiver do not have explicit references to each other, e.g. a

TCP connection is a referentially coupled model, a messaging brokerage isn't.

To allow cross-chain communication while maintaining a high level of decentralization, the system 100 does not rely on mechanisms which bind a SC node to an external network node (the MC for instance) and have all cross-chain messages traverse the chains via temporally and referentially coupling procedure calls.

In order to increase the decentralization of the overall network, a shared data storage (a decentralized files system such as the InterPlanetary File System (IPFS)) is used.

A. IPFS as a communication protocol

IPFS is a distributed file storage built on top of the libp2p library. Using either connected peers or the global DHT (Distributed Hash Table), IPFS allows a user to retrieve and deliver content via its content identifier (cid) over the p2p (peer-to-peer) network.

At a high-level, IPFS leveraged in the following manner:
The MC publishes its finalized blocks (to be fetched by (SCᵢ [symbol]
SC publish their Cert (to be fetched by the MC and their Listeners)

To allow content discovery on the network a way for actors to advertise their newly published data is used. In some embodiments, the IPFS pubsub feature is used. Data resolvers subscribe to topics which are fed by data publishers, all without any referential coupling between them.

A possible limitation is that the IPFS pubsub feature comes with no authentication mechanism, thus does not prevent an external actor, aware of the right topic, to publish erroneous data that will be pushed to all actors on multiple chains, effectively spamming and potentially creating vectors of attacks.

Another solution is found in the InterPlanetary Name System (IPNS) which introduces mutable pointers to content identifiers.

A name in IPNS is the hash of a public key. In the DHT, particular records connect IPNS names to information about the content identifiers they point to, information that is signed with the corresponding private key and versioned with a sequence number.

New DHT records can be signed, versioned and published at any time by any IPFS node owning the aforementioned private key.

IPNS also comes with its own pubsub feature that allows IPNS publishers to push records to a name-specific pubsub topic, in addition to the DHT. IPNS resolvers subscribe to the name-specific topic on the first name resolution and receive subsequent records through pubsub in real time.

The default name used by IPNS is the hash of the node's PeerId. Alternatively, a node can generate a new pair of keys (a public and a private one) and use the hash of the public key as a new name under which any holder of the associated private key can sign and publish data.

Relatively to the XCP, IPNS represents a very practical option, such as in the following scenario:

A blockchain has a pair of keys (a private one k to sign data to be published, a public one K to verify the associated signatures). This pair of keys may be generated at the creation of the chain. Nodes that have access to the private key k (either all or an authorized subset) can sign and publish some data under the hash of the associated public key K.

B. Robust Data Transmission

The above flow requires nodes of a blockchain to share a common private key without this key being leaked. However, the trustless nature of blockchain makes this requirement impossible to enforce in practice. This limitation is solved by adapting FROST (Flexible Round-Optimized Schnorr Threshold Signatures), a secret sharing scheme for publishing on IPFS. This scheme allows the set of validators of a chain to own shares of a private key. Upon agreeing on the data to be published on IPFS, a certain threshold of them is required to cooperate in order to sign the data, without leakage of information regarding each participant's share. The scheme also allows the network to detect, identify and report misbehaving signers during the signing process.

Since the set signs the data for a specific private key, a malicious participant is prevented from publishing wrong data, and it ensures that only a single data is published on IPFS per signing session. If at any point, a malicious participant leaks their own signing share, nothing happens.

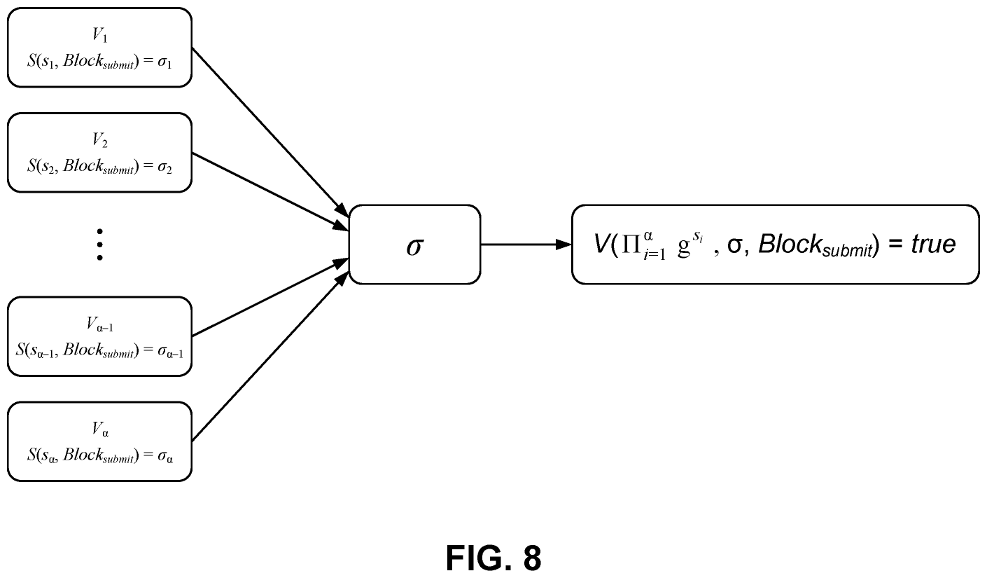

The scheme described above can be applied on the MC, where the set of participants would be the set of validators (Vᵢ)_{i∈[n]} and the data to be published on IPFS would be the latest finalized block. FIG. 8 illustrates a process for combining private shares to generate a valid signature a on a specific data, according to one or more embodiments. This scheme can also be used for any SC to publish their Cert.

The scheme fails if at least one participant in the signing set is malicious so the scheme is not robust (a robust scheme ensures that even with errors in the input or during the computation, the computation eventually converges to the correct output meaning that the protocol will complete successfully). The protocol should continue to work as well as possible under a variety of possible security assumptions e.g. FROST-based scheme failure. A fallback mechanism may be used in case of failure of the primary scheme.

The secondary scheme leverages erasure coding and its fault tolerance properties. More specifically, a Reed-Solomon encoding of (n, f+1) over Finite Field of 2¹⁶ elements where n is the number of MC or SC validators and

$$f = [ \frac{n - 1}{3} ]$$

is used to implement the availability scheme. It goes as follows (without loss of generality, only the case of SC Cert publication is detailed; for simplicity, it is assumed that the SC has similar structure as the MC):
The Cert producer (same as block producer for the associated Cert) produces the chunks and also the Merkle root of all the chunks
The Cert producer distributes one chunk per validator, for all validators (along with the Merkle root of all the chunks)
Every validator in the erasure coding protocol publishes its share on IPFS, returning a cid
Each validator publishes on IPNS, under their peerId associated IPNS name, their chunk cid
The MC nodes will randomly query f+1 chunks (from random IPNS names)
Once the MC nodes receive the totality of the f+1 chunks, they reconstruct the Cert and check it against the Merkle root
The MC nodes accept the Cert as available and proceed with its verification

If f+1-out-of-n correct shares are published, then the MC resolvers know that the Cert exist and is available and then know that either:
The Cert is properly constructed and is valid so the MC and Listeners would accept the Cert and the transactions inside it.
The Cert is properly constructed and is invalid so the MC and Listeners would reject the Cert and the transactions inside it, and possibly cease the SC.
The Cert is not properly constructed so the MC and Listeners would reject the Cert and the transactions inside it, and possibly cease the SC.

C. IPNS Name Lifecycle

In some embodiments, the set of chain participants that control data over IPNS may be not immovable, For example, elected MC validators, in charge of the authorship and publication of the blocks, are acting for a fixed time period (one era) before another election is conducted. Such ephemerality of data ownership implies that IPNS names are changing over time and thus that data resolvers must be notified of new names in order to continue fetching data.

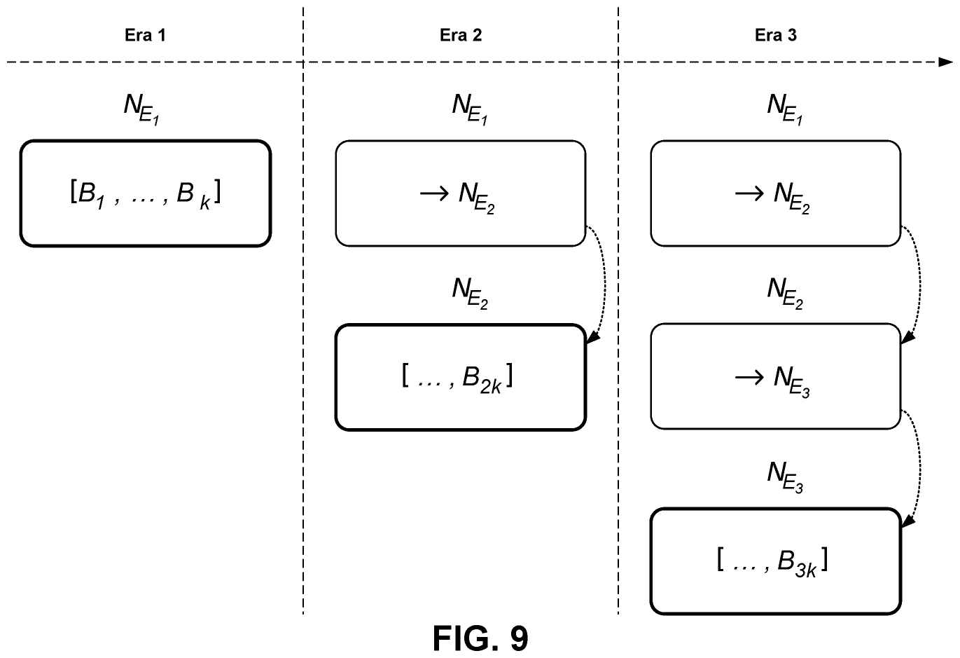

FIG. 9 illustrates a timing diagram for data published under IPNS names over time. FIG. 9 illustrates the case of the publication of the MC blocks.

For a consensus era Eᵢ composed of k blocks published to IPFS and represented by their IPFS cid B_{j∈[k]}. N_{E}_{ᵢ} is the IPNS name that is owned by the validators of era Eᵢ.

When N_{E}_{ᵢ₊₁} is created at era Eᵢ₊₁, the previous set of validators publishes N_{E}_{ᵢ₊₁} value (the name as a string) under the N_{E}_{ᵢ} name they still own. This allows N_{E}_{ᵢ₊₁} to be advertised to all data resolvers currently fetching data under N_{E}_{ᵢ}.

D. Initial IPNS Names at Bootstrapping

As described above, when bootstrapping, a SC provides the MC with its initial IPNS name (or IPNS names in case the SC uses the secondary scheme for robust data transmission). Once stored on the MC, the initial name(s) can be retrieved by MC validators and Listeners to start resolving the Cert of the SC.

On the other side, sidechains planning to start resolving MC blocks can do so by retrieving the currentMC IPNS name directly from the chain.

E. Data Availability

Light nodes sync all the blocks headers of the chain they are “following.” From the block header light nodes can query specific transactions to increase their confidence that the block is available, but cannot be certain, unless they query each and every transaction, but that would make them full nodes. Thus, an adversary producing blocks can just not publish parts of the block (say the parts that were not queried by the light nodes). This makes the block unavailable, and in this case the chain cannot fulfill the liveness property anymore. The probability of detecting at least one unavailable transaction grows with the number of light nodes querying transactions.

To enforce data availability, the protocol requires SC to permanently provide their Cert by pinning them. Pinning is an IPFS feature that prevents garbage collection from removing the data from the node's local store. Instead, the data remains available and linkage up to date in the DHT.

The whole list of Cert available at any time to be able to fetch past XC transactions as it may be required by particular applications.

Theoretically, not pinning the Cert poses no security issues to a newly joining SC as it can just trust the MC (recall the initial assumption that the MC is honest), fetch the latest MMR_root and append from there.

If all Cert are not pinned (i.e. not available), then a newly joining SC cannot reconstruct the MMR_root without querying the MC.

### Other Considerations

There is a possibility for any already existing blockchain to be interoperable with the system described herein. Blockchains which are not part of the network 105 were not created via the special transaction on the MC 110, but they could still interact with sidechains 120 by fetching the vk of the sidechains they want to interact with, update their code to support the SNARK of the sidechains and support MC_coin.

### Computing Machine Architecture

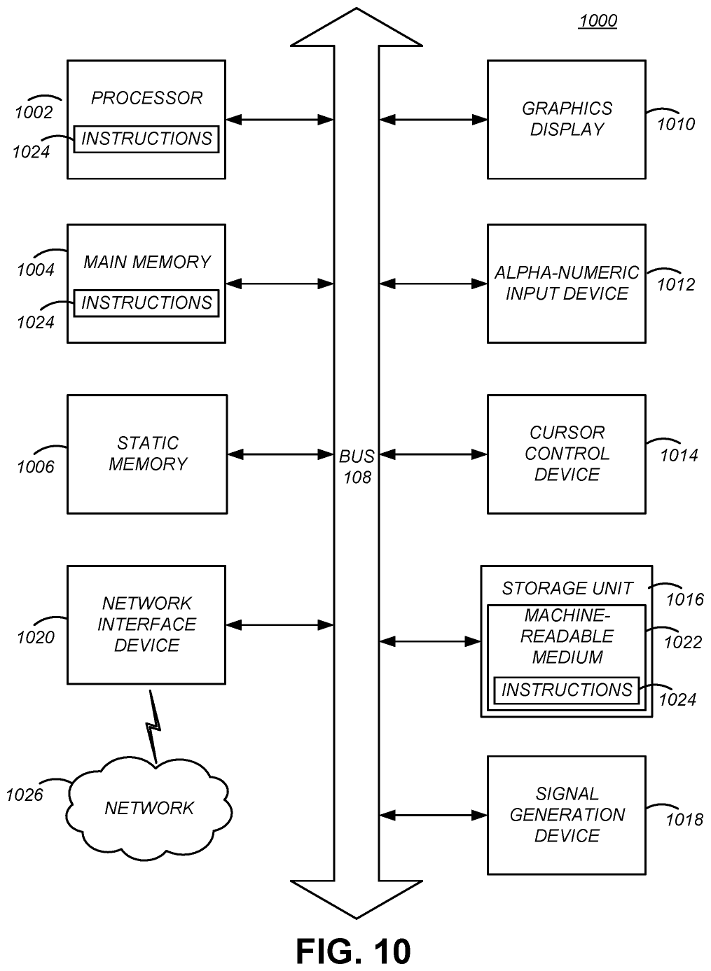

FIG. 10 is a block diagram illustrating components of an example machine able to read instructions from a machine-readable medium and execute them in a processor (or controller). Specifically, FIG. 10 shows a diagrammatic representation of a machine in the example form of a computer system 1000 within which instructions 1024 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes a processor 1002 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1004, and a static memory 1006, which are configured to communicate with each other via a bus 1008. The computer system 1000 may further include graphics display unit 1010 (e.g., a plasma display panel (PDP), a liquid crystal display (LCD), a projector, or a cathode ray tube (CRT)). The computer system 1000 may also include alphanumeric input device 1012 (e.g., a keyboard), a cursor control device 1014 (e.g., a mouse, a trackball, a joystick, a motion sensor, or other pointing instrument), a storage unit 1016, a signal generation device 1018 (e.g., a speaker), and a network interface device 820, which also are configured to communicate via the bus 1008.

The storage unit 1016 includes a machine-readable medium 1022 on which is stored instructions 1024 (e.g., software) embodying any one or more of the methodologies or functions described herein. The instructions 1024 (e.g., software) may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 (e.g., software) may be transmitted or received over a network 1026 via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., instructions 1024) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
receiving a certificate for a cross-chain transaction processed by a sidechain;
retrieving a verification key associated with the sidechain;
verifying the validity of the certificate using a zero-knowledge proof based on the verification key associated with the sidechain;
receiving information related to the cross-chain transaction processed by the sidechain; and
responsive to determining the validity of the certificate, processing the cross-chain transaction.

2. The method of claim 1, further comprising responsive to processing the cross-chain transaction, sending an acknowledgment for the cross-chain transaction.

3. The method of claim 1, wherein the verification key is retrieved from a mainchain where the sidechain is registered.

4. The method of claim 1, wherein the certificate is received from a distributed file system, and wherein receiving the certificate for the cross-chain transaction processed by the sidechain comprises:
retrieving a storage identifier within the distributed file system associated with the sidechain;
accessing the distributed file system at the storage identifier associated with the sidechain; and
retrieving the certificate from the distributed file system.

5. The method of claim 4, wherein the distributed file system is an InterPlanetary File System (IPFS).

6. The method of claim 4, wherein the storage identifier associated with the sidechain is an InterPlanetary Name System (IPNS) name.

7. The method of claim 4, wherein the storage identifier associated with the sidechain is retrieved from a mainchain where the sidechain is registered.

8. The method of claim 1, wherein the sidechain publishes the certificate responsive to processing the cross-chain transaction.

9. A non-transitory computer readable storage medium comprising stored instructions, the instructions comprising instructions that when executed by a processor cause the processor to:
receive a certificate for a cross-chain transaction processed by a sidechain;
retrieve a verification key associated with the sidechain;
verify the validity of the certificate using a zero-knowledge proof based on the verification key associated with the sidechain;
receive information related to the cross-chain transaction processed by the sidechain; and
process the cross-chain transaction when the validity of the certificate determined.

10. The non-transitory computer readable storage medium of claim 9, further comprising instructions that when executed by the processor causes the processor to transmit an acknowledgment for the cross-chain transaction after the cross-chain transaction is processed.

11. The non-transitory computer readable storage medium of claim 9, further comprises instructions that when executed by the processor causes the processor to retrieve the verification key from a mainchain where the sidechain is registered.

12. The non-transitory computer readable storage medium of claim 9, wherein the certificate is received from a distributed file system, and wherein the instructions to receive the certificate for the cross-chain transaction processed by the sidechain comprises further instructions that when executed by the processor causes the processor to:
retrieve a storage identifier within the distributed file system associated with the sidechain;
access the distributed file system at the storage location associated with the sidechain; and
retrieve the certificate from the distributed file system.

13. The non-transitory computer readable storage medium of claim 12, wherein the distributed file system is an InterPlanetary File System (IPFS).

14. The non-transitory computer readable storage medium of claim 12, wherein the storage identifier associated with the sidechain is an InterPlanetary Name System (IPNS) name.

15. The non-transitory computer readable storage medium of claim 12, further comprising instructions that when executed by the processor causes the processor to retrieve the storage identifier associated with the sidechain from a mainchain where the side chain is registered.

16. The non-transitory computer readable storage medium of claim 9, further comprises instructions that when executed by the processor causes the processor to publish, by the sidechain, the certificate responsive to processing the cross-chain transaction.

17. A system comprising:
a mainchain configured to store information associated with a plurality of sidechains; and
a first sidechain configured to process one or more cross-chain transactions; and
a second sidechain, the second sidechain configured to:
receive a certificate for a cross-chain transaction processed by the first sidechain;
retrieve, from the mainchain, a verification key associated with the first sidechain;
verify the validity of the certificate using a zero-knowledge proof based on the verification key associated with the first sidechain;
receive information related to the cross-chain transaction processed by the first sidechain; and
process the cross-chain transaction when the validity of the certificate determined.

18. The system of claim 17, wherein the second sidechain is further configured to transmit an acknowledgment for the cross-chain transaction after the cross-chain transaction is processed.

19. The system of claim 17, further comprising:
a distributed file system configured to store and distribute certificates for the one or more cross-chain transactions processed by the first sidechain, and
wherein the second sidechain is further configured to:
retrieve, from the mainchain, a storage identifier within the distributed file system associated with the first sidechain;
access the distributed file system at the storage location associated with the first sidechain; and
retrieve the certificate from the distributed file system.

20. The system of claim 19 wherein the distributed file system is an InterPlanetary File System (IPFS) and wherein the storage identifier associated with the first sidechain is an InterPlanetary Name System (IPNS) name.
